(19) United States
(12) Patent Application Publication
(10) Pub. No.: US 2025/0102756 A1
(43) Pub. Date: Mar. 27, 2025

(54) CABLE RETAINER CONFIGURED TO MAXIMIZE SPACE FOR A CABLE IN A PROFILE

(71) Applicant: PPC BROADBAND, INC., East Syracuse, NY (US)

(72) Inventors: Karl FLEMMING, Teltow (DE); Andreas LEYER, Potsdam (DE)

(73) Assignee: PPC BROADBAND, INC., East Syracuse, NY (US)

(21) Appl. No.: 18/892,999

(22) Filed: Sep. 23, 2024

Related U.S. Application Data
(60) Provisional application No. 63/539,634, filed on Sep. 21, 2023.

(51) Int. Cl. G02B 6/44; H02G 3/04; H02G 3/32

(52) U.S. Cl. CPC G02B 6/44785; G02B 6/4459; H02G 3/0437; H02G 3/32

(57) ABSTRACT

A cable retainer may be structurally configured to be coupled with a profile of a fiber distribution cabinet so as to retain a cable in the profile and maximize space in the profile. The cable retainer may include an inner retaining portion structurally configured to be received in a cable receiving portion in a profile of a fiber distribution cabinet, a neck portion extending from the inner retaining portion and structurally configured to be received in an opening through a wall portion of the profile to the cable receiving portion, an outer retaining portion structurally configured to extend from the neck portion in a direction away from the inner retaining portion. The inner retaining portion may be structurally configured to pass through the opening when disposed in a first orientation relative to the opening, and wherein the inner retaining portion is structurally configured to be prevented from passing through the opening when disposed in a second orientation relative to the opening. The neck portion may be structurally configured to permit the inner retaining portion to be rotated relative to the profile from the first orientation to the second orientation when the neck portion is received in the opening such that the inner retaining portion is configured to engage an inner surface portion of the wall portion and the outer retaining portion is configured to engage an outer surface portion of the wall portion so as to couple the retainer with the profile and retain a cable in the cable receiving portion. The inner retaining portion may be configured to extend into the cable receiving portion by a thickness of the inner retaining portion such that the thickness of the inner retaining portion is configured to be less than about 1.9 mm so as to maximize a space in the cable receiving portion between the inner retaining portion and the bottommost wall portion.

### CROSS REFERENCE TO RELATED APPLICATION

This application claims the benefit of U.S. Provisional Patent Application No. 63/539,634, filed Sep. 21, 2023, the contents of which are incorporated herein by reference.

### TECHNICAL FIELD

The present disclosure relates generally to a cable retainer. In particular, the disclosure relates to a cable retainer configured to maximize space for a cable or other item in a slot of a profile in a fiber distribution cabinet.

### BACKGROUND

In electronic enclosures, such as in a fiber distribution cabinet, one or more cables (or other items) often need to be routed in an orderly manner within the enclosures. The routing of the cables can take place in various manners, such as securing the cables in a particular manner within the enclosure. A common method of routing and securing cables within an enclosure is to use a slotted profile, which may be attached to the enclosure. The slotted profile may include a slot for retaining and routing the cable(s) within the enclosure. In such a profile, the slot may be configured to receive the cable(s) to route the cables within the enclosure. In some instances, such a profile may be known as a “T-slotted profile”.

In the use of such a profile, there may be a cap or retaining device that is inserted into a top open portion of the slot of the profile to retain the cable within the slot of the profile. However, such a cap or retainer may protrude within the slot and not leave enough room for the cable(s) in the slot of the profile.

It may be desirable to provide a retainer for a profile configured to maximize space for retaining the cable(s) within the slot of the profile.

### SUMMARY

In various embodiments of the present disclosure, a cable retainer may be structurally configured to be coupled with a profile of a fiber distribution cabinet so as to retain a cable in the profile and maximize space in the profile. The cable retainer may include an inner retaining portion structurally configured to be received in a cable receiving portion in a profile of a fiber distribution cabinet, a neck portion extending from the inner retaining portion and structurally configured to be received in an opening through a wall portion of the profile to the cable receiving portion, an outer retaining portion structurally configured to extend from the neck portion in a direction away from the inner retaining portion, and a receiving portion in the outer retaining portion structurally configured to receive and retain a received element. The inner retaining portion may be structurally configured to pass through the opening when disposed in a first orientation relative to the opening, and wherein the inner retaining portion is structurally configured to be prevented from passing through the opening when disposed in a second orientation relative to the opening. The outer retaining portion may be configured to prevent insertion of the outer retaining portion into the opening. The neck portion may be structurally configured to permit the inner retaining portion to be rotated relative to the profile from the first orientation to the second orientation when the neck portion is received in the opening such that the inner retaining portion is configured to engage an inner surface portion of the wall portion and the outer retaining portion is configured to engage an outer surface portion of the wall portion so as to couple the retainer with the profile and retain a cable in the cable receiving portion. The inner retaining portion may be configured to extend into the cable receiving portion by a thickness of the inner retaining portion such that the thickness of the inner retaining portion is configured to be less than 25% of a dimension of the cable receiving portion from the inner surface portion of the wall portion to a bottommost wall portion of the cable receiving portion so as to maximize a space in the cable receiving portion between the inner retaining portion and the bottommost wall portion.

A cable retainer may be structurally configured to be coupled with a profile of a fiber distribution cabinet so as to retain a cable in the profile and maximize space in the profile. The cable retainer may include an inner retaining portion structurally configured to be received in a cable receiving portion in a profile of a fiber distribution cabinet, a neck portion extending from the inner retaining portion and structurally configured to be received in an opening through a wall portion of the profile to the cable receiving portion, an outer retaining portion structurally configured to extend from the neck portion in a direction away from the inner retaining portion. The inner retaining portion may be structurally configured to pass through the opening when disposed in a first orientation relative to the opening, and wherein the inner retaining portion is structurally configured to be prevented from passing through the opening when disposed in a second orientation relative to the opening. The neck portion may be structurally configured to permit the inner retaining portion to be rotated relative to the profile from the first orientation to the second orientation when the neck portion is received in the opening such that the inner retaining portion is configured to engage an inner surface portion of the wall portion and the outer retaining portion is configured to engage an outer surface portion of the wall portion so as to couple the retainer with the profile and retain a cable in the cable receiving portion. The inner retaining portion may be configured to extend into the cable receiving portion by a thickness of the inner retaining portion such that the thickness of the inner retaining portion is configured to be less than 25% of a dimension of the cable receiving portion from the inner surface portion of the wall portion to a bottommost wall portion of the cable receiving portion so as to maximize a space in the cable receiving portion between the inner retaining portion and the bottommost wall portion.

A cable retainer may be structurally configured to be coupled with a profile of a fiber distribution cabinet so as to retain a cable in the profile and maximize space in the profile. The cable retainer may include an inner retaining portion structurally configured to be received in a cable receiving portion in a profile of a fiber distribution cabinet, a neck portion extending from the inner retaining portion and structurally configured to be received in an opening through a wall portion of the profile to the cable receiving portion, an outer retaining portion structurally configured to extend from the neck portion in a direction away from the inner retaining portion. The inner retaining portion may be structurally configured to pass through the opening when disposed in a first orientation relative to the opening, and wherein the inner retaining portion is structurally configured to be prevented from passing through the opening when disposed in a second orientation relative to the opening. The neck portion may be structurally configured to permit the inner retaining portion to be rotated relative to the profile from the first orientation to the second orientation when the neck portion is received in the opening such that the inner retaining portion is configured to engage an inner surface portion of the wall portion and the outer retaining portion is configured to engage an outer surface portion of the wall portion so as to couple the retainer with the profile and retain a cable in the cable receiving portion. The inner retaining portion may configured to extend into the cable receiving portion by a thickness of the inner retaining portion such that the thickness of the inner retaining portion is configured to be less than about 1.9 mm so as to maximize a space in the cable receiving portion between the inner retaining portion and the bottommost wall portion.

### BRIEF DESCRIPTION OF THE DRAWINGS

Further advantages and features of the present disclosure will become apparent from the following description and the accompanying drawings, to which reference is made. In which are shown:

FIG. 1 illustrates an enclosure with wiring and profiles according to the present disclosure,

FIG. 2 illustrates a perspective view of a profile and a retainer according to the present disclosure.

FIG. 3 illustrates a side view of a profile and a retainer according to the present disclosure.

FIG. 4 illustrates a side view of a profile with dimensions according to the present disclosure.

FIG. 5 illustrates a side view of a profile and a retainer with dimensions according to the present disclosure.

FIG. 6 illustrates perspective views of various retainers according to the present disclosure.

FIG. 7 illustrates bottom, side and top views of various example retainers according to the present disclosure.

FIG. 8 illustrates various views of a retainer in accordance with the present disclosure.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

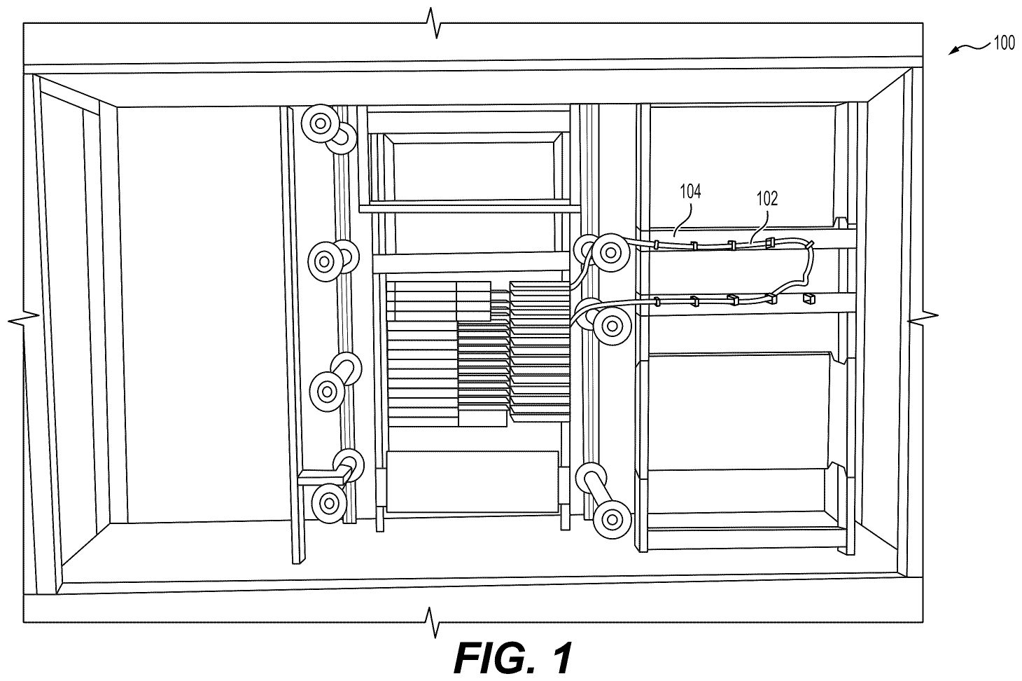

FIG. 1 illustrates an enclosure 100 according to the present disclosure. The enclosure 100 may including wiring or cables 102 and profiles 104. The profiles 104 may be configured as slotted profiles that have one or more slots. The slots may be configured to receive and retain the wiring 102 such that the wiring 102 may be arranged in the enclosure with at least part of the wiring 102 within one or more slots of at least one of the profiles.

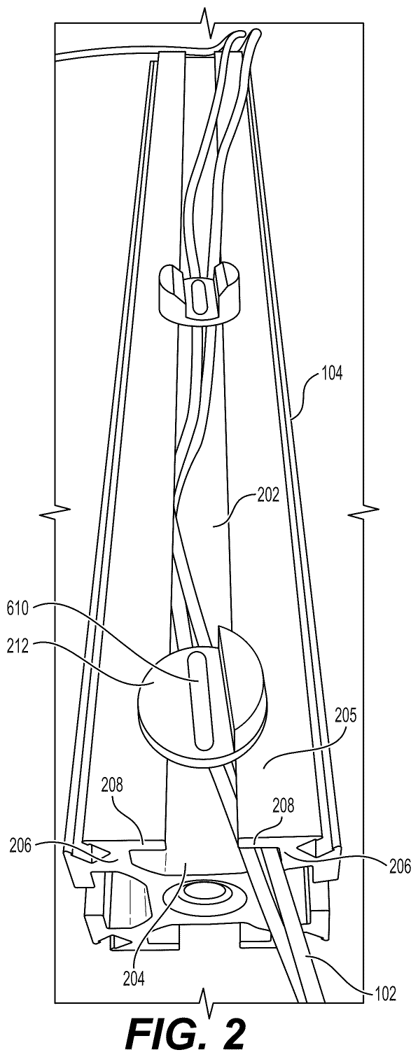

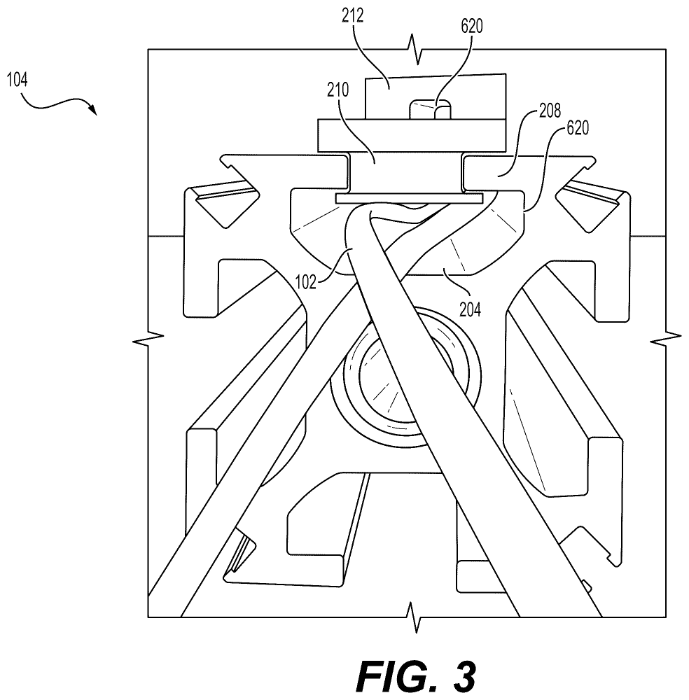

Referring to FIGS. 2 and 3, an exemplary profile 104 is illustrated. The profile 104 is illustrated with slots or channels 202. The profile 104 may include only one slot 202 or a plurality of slots 202. In the embodiment illustrated, there are four slots 202 in the profile 104, although any number of slots 202 could be used in various embodiments. The slots 202 may be configured to receive the wires 102 so that the wires can be routed and retained in the slots 202 of the profile 102. In various embodiments, a retainer 212 may be inserted into the profile 104 to retain the wires 102 in the slot 202, as further discussed herein.

The profile 104 may have an outer surface 205, in which slots with an inverted T-shape are present, although other shapes could be used. As illustrated in FIGS. 2 and 3, the slot 202 may include a bottom wall or portion 204, side walls 206 and top walls 208. The side walls 206 may extend substantially vertically, although the side walls 206 could be angled or have a portion of the side walls angled with angled portions 207. The top walls 208 may extend substantially horizontally inward from the side walls 206 and may have a gap or opening 210 between inner edges of each top wall 208. The opening 210 may be configured with a width to receive the wires 102. The retainer 212 may be inserted into the opening 210 of the profile to retain or secure the wires 102 in the slot 202 of the profile 104.

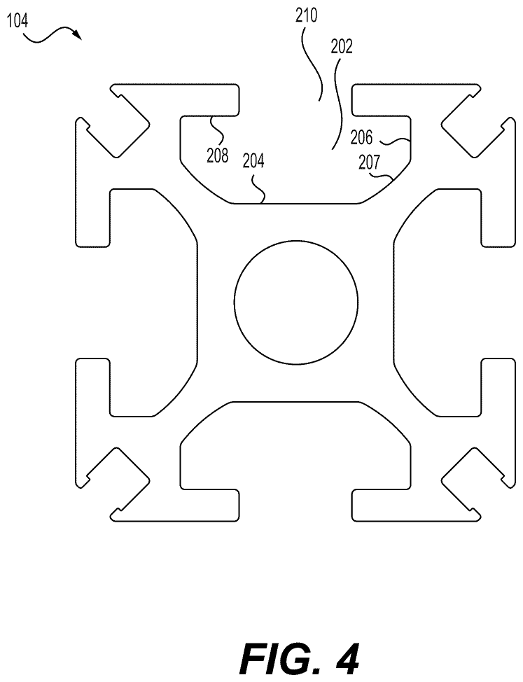

FIG. 4 illustrates various possible dimensions in mm of the profile 104, although other dimensions could be used. The possible dimensions of the profile 104 may include the top walls 208 having a vertical thickness of about 3 mm, the slot 202 having a depth from a top of the top wall 208 to the bottom wall 204 of about 11 mm, a width between the side wall of about 21 mm and a width of the opening 210 of about 10.2 mm, as well as the other dimensions illustrated.

The retainer 212 may be structurally configured to fit into the opening 210 and to selectively lock into the opening 210. The retainer 212 may also be structurally configured to be removable from the opening 210 upon manipulation by a user as further explained herein.

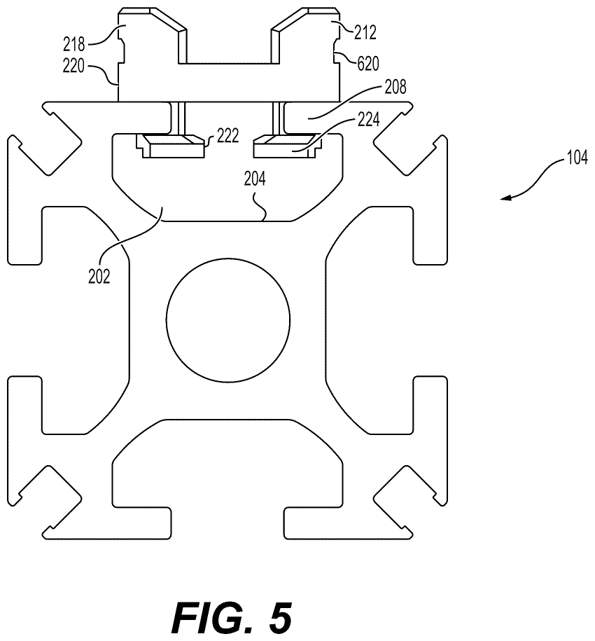

FIG. 5 illustrates an example profile 104 with a retainer 212 inserted into the opening 210. The retainer 212 is structurally configured to be insertable into the opening 210 and locked into place to retain any cables, wires or other items in the slot 202. In various embodiments, after the retainer 212 is inserted into the profile 104, the retainer 212 may be turned or rotated to lock the retainer 212 in place in the profile 104. The retainer 212 may be configured with an upper portion (outer retaining portion) 218, a middle portion (neck portion) 220 and a lower portion (inner retaining portion) 222.

When the retainer 212 is inserted into and locked in the profile 104, the upper portion 218 and the middle portion 220 of the retainer 212 are structurally configured to be disposed on top of the profile 104, while the lower portion 222 of the retainer 212 is structurally configured to engage the inner portion of the top walls 208 of the profile. The lower portion 222 may include vertically extending portions 224 that are structurally configured to engage with the top walls 208 of the slot when the retainer is inserted in the opening 210 and rotated.

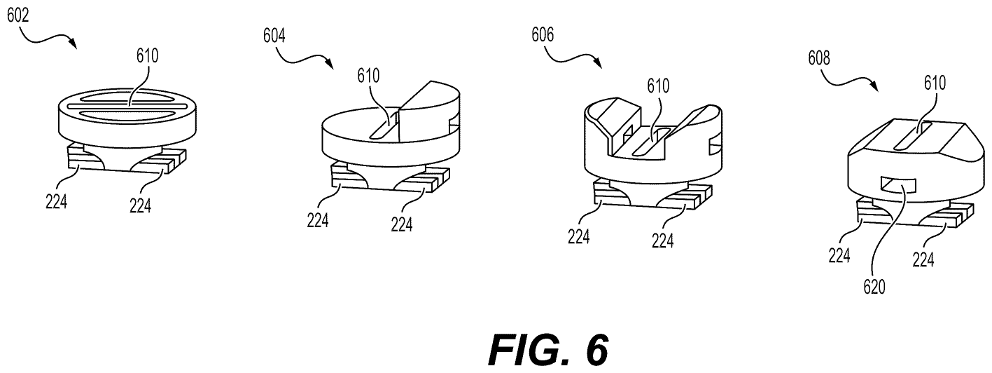

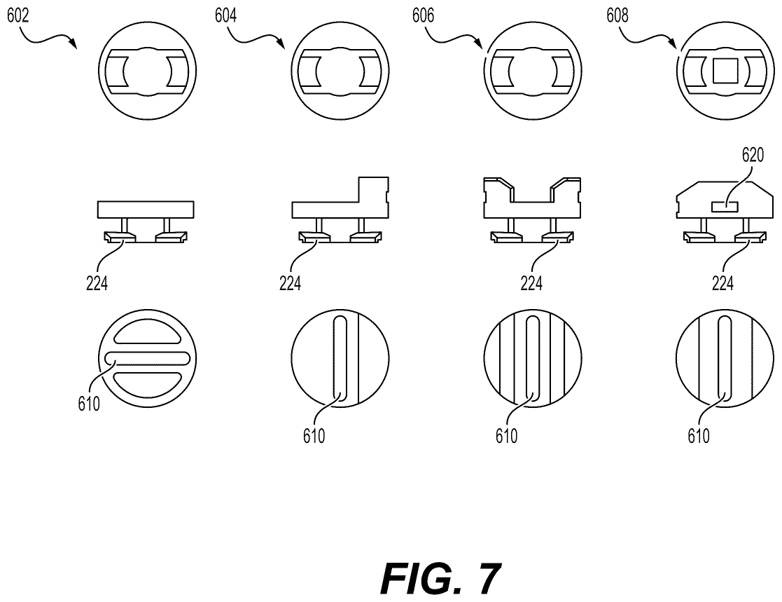

FIGS. 6 and 7 illustrate four example profiles 602, 604, 606 and 608. The profiles 602, 604, 606 and 608 have different upper portions but share the same lower portion. The profiles 604, 606 and 608 may be configured with a receiving portion 620, which may be in the form of an opening or slot. The receiving portion 620 may be configured to receive a cable or wire therein. The receiving portion 620 may have a vertical height of about 2.0 mm, although alternative heights could be used.

The retainers 602, 604, 606 and 608 have vertically extending portions 224 that extend vertically but the vertically extending portions 224 have a width so that they can fit within the opening 210 in the profiles 210 when the retainers 602, 604, 606 and 608 are inserted into the opening in the profile 210. When the retainers 602, 604, 606 or 608 are rotated after being inserted into the opening, the vertically extending portions 224 are structurally configured to engage with the top walls 208 of the corresponding profile to lock the retainer in position. Additionally, any of the retainers disclosed herein may include a rotation engagement portion 610 as illustrated in FIGS. 2 and 6-8. The rotation engagement portion 610 may be configured to receive a tool to assist in rotating the profile, such as a screwdriver. In various embodiments, the rotation engagement portion 610 may be a slot or opening formed in the retainer, although other types of rotation engagement portions could be used. In various embodiments, the profiles may also be rotated by hand.

FIG. 7 illustrates bottom, top and side views of the retainers 602, 604, 606 and 608. The rotation engagement portions 610 are illustrated in the top view.

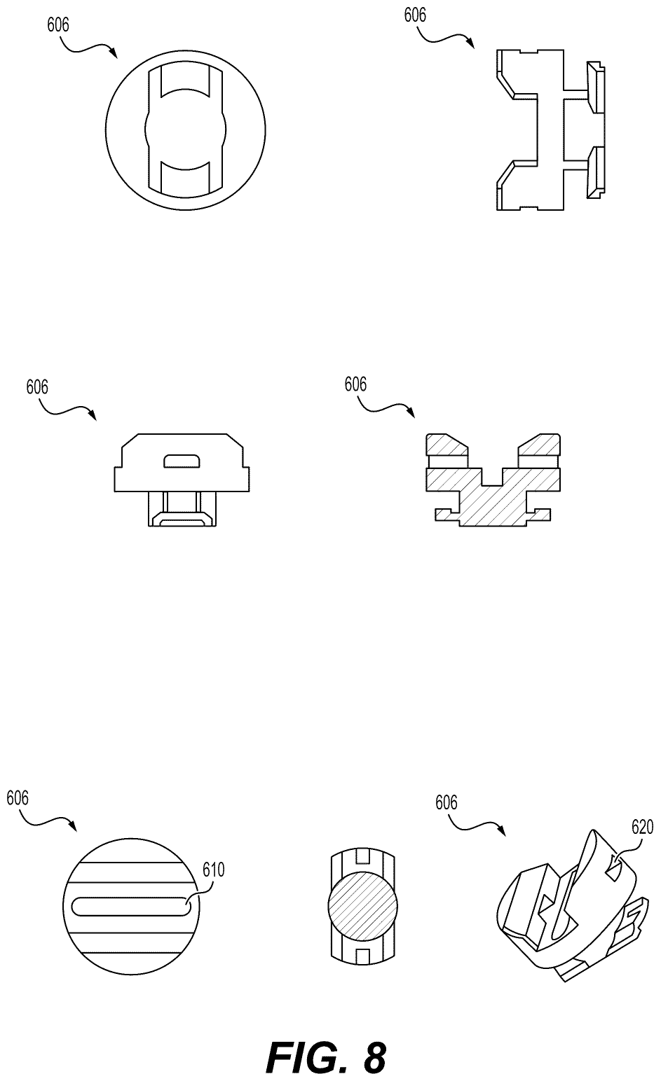

FIG. 8 illustrates various views and dimensions of the retainer 606. A vertical height (or thickness) of the vertically extending portions 224 may be reduced to about 2.0 mm, as illustrated in FIG. 5. As illustrated in FIG. 8, a vertical height (or thickness) of the vertically extending portions 224 may be reduced to about 1.9 mm. The vertically extending portions 224 are given this “low profile” to provide an enhanced or increased space in the slot 202 for the cables, wires or other items. In this way, numerous cables or wires can be placed within the slot 202 and the vertically extending portions 224 of the retainers will leave sufficient space in the slots 202 for the cables or wires when the retainer is inserted into the profile and locked in place. Without such a low profile of the protrusion portions of the retainer, the protrusion portions could be pressed against the wires and could cause damage to the wires or not properly lock the retainer into position. The low profile of the vertically extending portions 224 thus provides enhanced space in the slot of the profile for the wires. For example, in the embodiment of FIG. 5, there may be 6 mm or more of enhanced or increased space in the slot 202 below the vertically extending portions 224 for retaining the wires in the slot 202. The vertically extending portions 224 may thus have a reduced thickness of about 25% or less of the depth of the slot measured from the top wall 208 to the bottom wall 204, although a lower percentage may be used when the slot has a greater depth than this example.

The protrusion portions may have a horizontal width of about 17 mm, as illustrated in FIG. 8. Other dimensions of the protrusion portions could be utilized with various embodiments.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A cable retainer structurally configured to be coupled with a profile of a fiber distribution cabinet so as to retain a cable in the profile and maximize space in the profile comprising:
an inner retaining portion structurally configured to be received in a cable receiving portion in a profile of a fiber distribution cabinet;
a neck portion extending from the inner retaining portion and structurally configured to be received in an opening through a wall portion of the profile to the cable receiving portion;
an outer retaining portion structurally configured to extend from the neck portion in a direction away from the inner retaining portion;
a receiving portion in the outer retaining portion structurally configured to receive and retain a received element;
wherein the inner retaining portion is structurally configured to pass through the opening when disposed in a first orientation relative to the opening, and wherein the inner retaining portion is structurally configured to be prevented from passing through the opening when disposed in a second orientation relative to the opening;
wherein the outer retaining portion is configured to prevent insertion of the outer retaining portion into the opening;
wherein the neck portion is structurally configured to permit the inner retaining portion to be rotated relative to the profile from the first orientation to the second orientation when the neck portion is received in the opening such that the inner retaining portion is configured to engage an inner surface portion of the wall portion and the outer retaining portion is configured to engage an outer surface portion of the wall portion so as to couple the retainer with the profile and retain a cable in the cable receiving portion; and
wherein the inner retaining portion is configured to extend into the cable receiving portion by a thickness of the inner retaining portion such that the thickness of the inner retaining portion is configured to be less than 25% of a dimension of the cable receiving portion from the inner surface portion of the wall portion to a bottommost wall portion of the cable receiving portion so as to maximize a space in the cable receiving portion between the inner retaining portion and the bottommost wall portion.

2. The cable retainer of claim 1, wherein the thickness of the inner retaining portion is about 1.9 mm.

3. The cable retainer of claim 1, wherein the receiving portion is configured with an opening having a vertical height of about 2.0 mm.

4. The cable retainer of claim 1, wherein the inner retaining portion is configured with vertically extending portions structurally configured to engage with the inner surface portion of the wall portion when the cable retainer is inserted into the opening and rotated to lock the cable retainer into the profile.

5. The cable retainer of claim 4, wherein the vertically extending portions have a vertical width of about 17 mm.

6. The cable retainer of claim 1, wherein the receiving portion is configured to be disposed outside the opening when the cable retainer is inserted into the cable receiving portion.

7. A cable retainer structurally configured to be coupled with a profile of a fiber distribution cabinet so as to retain a cable in the profile and maximize space in the profile, comprising:
an inner retaining portion structurally configured to be received in a cable receiving portion in a profile of a fiber distribution cabinet;
a neck portion extending from the inner retaining portion and structurally configured to be received in an opening through a wall portion of the profile to the cable receiving portion;
an outer retaining portion structurally configured to extend from the neck portion in a direction away from the inner retaining portion;
wherein the inner retaining portion is structurally configured to pass through the opening when disposed in a first orientation relative to the opening, and wherein the inner retaining portion is structurally configured to be prevented from passing through the opening when disposed in a second orientation relative to the opening;
wherein the neck portion is structurally configured to permit the inner retaining portion to be rotated relative to the profile from the first orientation to the second orientation when the neck portion is received in the opening such that the inner retaining portion is configured to engage an inner surface portion of the wall portion and the outer retaining portion is configured to engage an outer surface portion of the wall portion so as to couple the retainer with the profile and retain a cable in the cable receiving portion; and
wherein the inner retaining portion is configured to extend into the cable receiving portion by a thickness of the inner retaining portion such that the thickness of the inner retaining portion is configured to be less than 25% of a dimension of the cable receiving portion from the inner surface portion of the wall portion to a bottommost wall portion of the cable receiving portion so as to maximize a space in the cable receiving portion between the inner retaining portion and the bottommost wall portion.

8. The cable retainer of claim 7, wherein the thickness of the inner retaining portion is about 1.9 mm.

9. The cable retainer of claim 8, wherein the inner retaining portion has vertically extending portions structurally configured to engage with the inner surface of the wall portion when the cable retainer is inserted into the opening and rotated to lock the cable retainer into the profile.

10. The cable retainer of claim 9, wherein the vertically extending portions have a vertical width of about 17 mm.

11. The cable retainer of claim 7, wherein the outer retaining portion is configured to prevent insertion of the outer retaining portion into the cable receiving portion.

12. The cable retainer of claim 7, further comprising a receiving portion configured in the outer retaining portion having a receiving opening with a vertical height of about 2.0 mm.

13. The cable retainer of claim 12, wherein the receiving portion is configured to be disposed outside the opening when the cable retainer is inserted into the cable receiving portion.

14. A cable retainer structurally configured to be coupled with a profile of a fiber distribution cabinet so as to retain a cable in the profile and maximize space in the profile, comprising:
an inner retaining portion structurally configured to be received in a cable receiving portion in a profile of a fiber distribution cabinet;
a neck portion extending from the inner retaining portion and structurally configured to be received in an opening through a wall portion of the profile to the cable receiving portion;
an outer retaining portion structurally configured to extend from the neck portion in a direction away from the inner retaining portion;
wherein the inner retaining portion is structurally configured to pass through the opening when disposed in a first orientation relative to the opening, and wherein the inner retaining portion is structurally configured to be prevented from passing through the opening when disposed in a second orientation relative to the opening;
wherein the neck portion is structurally configured to permit the inner retaining portion to be rotated relative to the profile from the first orientation to the second orientation when the neck portion is received in the opening such that the inner retaining portion is configured to engage an inner surface portion of the wall portion and the outer retaining portion is configured to engage an outer surface portion of the wall portion so as to couple the retainer with the profile and retain a cable in the cable receiving portion; and
wherein the inner retaining portion is configured to extend into the cable receiving portion by a thickness of the inner retaining portion such that the thickness of the inner retaining portion is configured to be less than about 1.9 mm so as to maximize a space in the cable receiving portion between the inner retaining portion and the bottommost wall portion.

16. The cable retainer of claim 15, wherein the thickness of the inner retaining portion is configured to be than 25% of a dimension of the cable receiving portion from the inner surface portion of the wall portion to a bottommost wall portion of the cable receiving portion.

17. The cable retainer of claim 15, wherein the inner retaining portion has vertically extending portions structurally configured to engage with the inner surface portion of the wall portion when the cable retainer is inserted into the opening and rotated to lock the cable retainer into the profile.

18. The cable retainer of claim 17, wherein the vertically extending portions have a vertical width of about 17 mm.

19. The cable retainer of claim 15, further comprising a receiving portion in the outer retaining portion structurally configured to receive and retain a received element, the receiving portion being configured to be disposed outside the opening when the cable retainer is inserted into the cable receiving portion

20. The cable retainer of claim 17, wherein the opening in the receiving portion has a vertical height of about 2.0 mm.
